(19) United States
(12) Patent Application Publication
(10) Pub. No.: US 2010/0203222 A1
(43) Pub. Date: Aug. 12, 2010

(54) PROCESS AND EQUIPMENT FOR THE EXTRUSION OF OILSEEDS DURING THE PROCESS OF PRETREATING OILSEEDS FOR SOLVENT EXTRACTION OF OIL

(75) Inventor: Shen Dechao, Zibo City (CN)

Correspondence Address: WINSTEAD PC, P.O. BOX 50784, DALLAS, TX, 75201, US

(73) Assignee: Shandong University of Technology

(21) Appl. No.: 12/700,990

(22) Filed: Feb. 5, 2010

(30) Foreign Application Priority Data
Feb. 6, 2009 (CN) CN 200910014133.3

(51) Int. Cl. C11B 1/02; A23P 1/12; A23N 1/00

(52) U.S. Cl. 426/632; 426/634; 426/518; 99/495

(57) ABSTRACT

A processing process and a processing equipment for the extrusion of oilseeds during the process of pretreating oilseeds for solvent extraction of oil to produce oils. The process and a processing equipment provides a reasonable parameters for the processing process for the extrusion of oilseeds, and the reasonable structure and parameters of the processing equipment for the extrusion of oilseeds which has a whole of cylinder-conical-cylinder combinational screws having a relatively small length-diameter ratio and a relatively large compression ratio, so that the extruded oilseed materials have a residual oil <1.0% and the extraction capability is increased by 60%-130% compared to prior art equipments. The processes and equipments for oilseeds cracking, softening, flaking and cooking used in the traditional process of pretreating oilseeds for solvent extraction of oil can be eliminated. Also can be eliminated are the processes and equipments for oilseeds cracking, softening, flaking, drying as well as for injection of steam and cooling water into the extruded oilseed materials, used in the domestic and over sea extrusion processes in the pretreatment of oilseeds for solvent extraction of oil.

### CROSS-REFERENCE TO RELATED APPLICATIONS

This application claims priority to Chinese Patent Application No. CN 200910014133.3, filed Feb. 6, 2009, which is incorporated by reference herein in its entirety.

### BACKGROUND

1. Technical Field

The present invention relates to a processing process and a processing equipment and, in particular, for extrusion of oilseeds during the process of pretreating oilseeds for solvent extraction of oil to produce oils.

2. History Of Related Art

Extrusion processing of oilseeds in the process of pretreating oilseeds for solvent extraction of oil is internationally recognized as an advanced technology for pretreating oilseeds.

The extrusion technology for use in the process of pretreating oilseeds for solvent extraction of oil, as exemplified by that owned by Anderson America Corp., is internationally recognized as advanced technology that can lower costs and increase yield. The company's pretreatment process for solvent extraction of oil involves the following steps: oilseeds cleaning→cracking→softening→flaking→extrusion processing (wherein pressurized hot steam and cooling water are directly injected into the extruded oilseeds between a screw and a barrel to heat and cool the extruded oilseeds)→drying→extraction. That is, the pretreatment process adds the processes and equipments of extrusion and drying to the traditional pretreatment process without the step of extruding oilseeds.

EP0341020 to Upchurch Ray, titled “Improved Soybean Process”, assigned to The French Oil Mill Machinery Company, discloses a technology that eliminates processes and equipments of softening, flaking and prepressing in the traditional pretreatment process and adds the process and equipment of extrusion expending. When conducting extrusion expending of soybean, the soybean materials entering an extruder have a particle size of 0.254 mm-0.508 mm, and pressurized hot steam is directly injected into the materials between the screw and the barrel to heat them. The extradite is subsequently subjected to the same process for solvent extraction of oil as traditionally used.

Many domestic patents or patent applications are related to this technical field. The extrusion processing processes disclosed for the pretreatment of oilseeds are essentially the same as that exemplified by Anderson America Corp., as in Chinese Patent Nos. 93243405.3 (entitled “Expending machine”), 94212300 (entitled “Extrusion expending machine for oilseeds”), 94211840.5 (entitled “Self-cleaning extrusion expending machine for oilseeds”), 00123281.9 (entitled “A manufacture process for the production of soybean oil by means of expending-extraction”), 02257004.7 (entitled “An extruder for the pre-pressing and expending of oilseeds”), and in Chinese Patent Application Nos 200510056861.2 (entitled “A process for low temperature production of oils and oilseed proteins from oilseeds”), 200620095166.7 (entitled “Multi-functional oil mill”), 200810102926 (entitled “A process for producing oils from low-oil-content oilseeds by expending and compression”), and 200810101254 (entitled “A process for producing oils from high-oil-content oilseeds by expending, pre-pressing and extraction”).

Chinese Invention Patent No. 98115743.2 (applicant: Northeast Agricultural University, inventor: Shen Dechao, title: Extrusion-expending processing of soybeans during the process of pretreating soybeans for solvent extraction of oil) discloses processes for pretreating soybeans for solvent extraction of oil involving the steps of: soybeans cleaning→comminuting→extrusion processing→extraction, which eliminates the processes and equipments of soybean cracking, softening, flaking and cooking used in the traditional processing and current advanced extrusion processing of pretreating soybeans for solvent extraction of oil. Experimental research and trial production showed that the extrusion processing process and processing equipment disclosed in the patent to Shen Dechao are applicable to the extrusion pretreatment of low-oil-content oilseeds.

For the extrusion pretreatment of high-oil-content oilseeds such as, for example, rape seeds, sunflower seeds, peanuts, corn germs, flax seeds and cotton seeds or the like, there can be mentioned the above-said extrusion technology for use in the process of pretreating oilseeds for solvent extraction of oil, as exemplified by that owned by Anderson America Corp. The extrusion equipment used for the process has a relatively long bar cage following a barrel with a discharge nozzle (die nozzle). Part of the oils in the extruded oilseeds is squeezed from the bar cage such that the extruded oilseeds are in an extruded porous state, which facilitates the subsequent extraction of the oilseed extrudate. Chinese Invention Patent No. 200410036404.2 (applicant: Shandong University of Technology, inventor: Shen Dechao, title: Extrusion-expending processing process and processing equipment for pretreating rape seeds for solvent extraction of oil) discloses a process of pretreating rape seeds, which comprises the following steps: oil seeds cleaning→comminuting→extrusion processing→extraction. Such a process eliminates the processes and equipments for oilseeds cracking, softening, flaking and cooking in the above-said process of Anderson America Corp. and in the traditional process of pretreating oilseeds for solvent extraction of oil. The extrusion equipment used for such a process also has in its proximal end a relatively long bar cage following the barrel with the discharge nozzle (die nozzle).

Experimental research and trial production indicated that, as the above-said extrusion equipment has a cylinder screw that has a large compression ratio and a length-diameter ratio, costs of manufacture, use and maintenance are relatively high. Therefore, further research is needed in order to reduce the costs and increase the quality and yield of the extraction of the oilseed extrudate. Moreover, the systemic parameters for the extrusion processing of oilseeds and the structural parameters for the extrusion processing equipment are not reasonable enough.

Only by overcoming shortcomings of the above-said prior art processes, can further simplification be made on the presently internationally advanced extrusion processing process and equipment for pretreating oilseeds for solvent extraction of oil, thereby achieving the goals of lowering costs and increasing quality and yield of the solvent extraction of oil.

### SUMMARY OF THE INVENTION

In order to address the above-mentioned issue, the present invention provides an extrusion processing equipment useful in a process of pretreating oilseeds for solvent extraction of oil, wherein the equipment is primarily comprised of an axially bisectable barrel set and a screw set.

The barrel set is comprised of a first barrel 2, a second barrel 4, a third barrel 5 and a fourth barrel 7 and a bar cage 8, wherein the first, second, third, and fourth barrels 2, 4, 5, 7 and the bar cage 8 are axially bisectable and the whole of the barrel set 8 is thus also axially bisectable. The first barrel 2, the second barrel 4, the third barrel 5, the fourth barrel 7 and the bar cage 8 are assembled in the order of numbering and can be closed when in operation by locking an upper part and lower part of each of the above-said barrels 2, 4, 5, 7 and the bar cage 8 with fasteners.

The screw set is comprised of a main shaft 17, a first screw 1, a second screw 6, a third screw 14 and a fourth screw 9. Each of the screws 1, 6, 14, 9 is installed enclosing main shaft 17 in the mentioned order and rotates with main shaft 17. The first screw 1, the second screw 6, the third screw 14 and the fourth screw 9 enclosing main shaft 17 have external threads in opposite rotational direction to continuous internal threads on an inner surface of the second barrel 4, the third barrel 5 and the fourth barrel 7. The external threads of the second screw 6, the third screw 14 and the fourth screw 9 have a helix angle substantially equal to a helix angle of the continuous internal threads on the inner surface of the second barrel 4, the third barrel 5 and the fourth barrel 7. The third screw 14 is a conical screw, and the first screw 1, the second screw 6 and the fourth screw 9 are all cylinder screws. The threads on the first screw 1, the second screw 6 and the third screw 14 are continuous threads, and the thread on the fourth screw 9 is an interrupted thread.

The first screw 1 corresponds to the first barrel 2 and the second barrel 4, the second screw 6 corresponds to the third barrel 5, the third screw 14 corresponds to the fourth barrel 7, and the fourth screw 9 corresponds to bar cage 8. The first screw 1 is connected to the second screw 6 through restrictive ring 16, the second screw 6 is connected to the third screw 14 through restrictive ring 15, the third screw 14 is connected to the fourth screw 9 through smooth ring 13, and the fourth screw 9 has restrictive ring 12 mounted thereon. After disassembling die plate 10 as well as the fasteners for the upper part and lower part of each of the above-said barrels and the bar cage, the two bisectable halves of the barrel set comprised of the corresponding two bisectable halves of the first barrel 2, the second barrel 4, the third barrel 5, the fourth barrel 7 and bar cage 8 assembled together can be rotated outward on shaft A and shaft B, respectively, so that the two bisectable halves of the barrel set are opened apart from each other.

The first barrel 2 is not heated or cooled. Outer surfaces of the second barrel 4, the third barrel 5 and the fourth barrel 7 are heated by pressurized hot steam or electricity and forcedly cooled by cooling water or air, the temperatures in the barrels being automatically adjustable. The bar cage 8 is electrically heated, its electrical connection being turned on or off along with the heating or cooling of the fourth barrel 7 and its temperature being automatically adjustable.

The volume between an end surface of the fourth screw 9 and an internal surface of die plate 10 may be, for example, 2 to 20 times an output volume produced when the end of the fourth screw 9 rotates one revolution. The screw set has a length-diameter ratio of approximately 3-20 and produces a compression ratio of approximately 5-35. A ratio of the diameter of the first screw 1 and the second screw 6 to a diameter of the fourth screw 9 is approximately 1.01-4.0. The second barrel 4 and the third barrel 5 have essentially the same length, the ratio of this length to the length of the fourth barrel 7 is approximately 1-0.3 and the ratio of this length to the length of bar cage 8 is approximately 1-0.2. A die nozzle 11 of the die plate 10 has an adjustable diameter ranging from about Φ4 mm to about Φ16 mm and an adjustable length ranging from about 8 mm to about 50 mm.

The present invention also provides an extrusion processing process for pretreating oilseeds for solvent extraction of oil. The process includes subjecting the oilseed raw materials having a moisture content percentage ≧15% to removing impurities, removing stones and removing iron, drying the oilseed raw materials at a low drying temperature below 50° C. to make the moisture content percentage ≦15%. The process further includes removing or not removing the hull of oilseeds, comminuting the oil seeds and passing the comminuted oilseeds through a sieve having a pore diameter of about Φ2 mm to about Φ5 mm, feeding the oilseeds treated as above through feeding hole 3 of the extrusion processing equipment into the equipment for extrusion processing. The first barrel 2 is not heated or cooled, the temperatures of the second barrel 4, the third barrel 5 and the fourth barrel 7 are automatically adjustably in the range of about 10° C. to about 95° C., about 10° C. to about 100° C. and about 20° C. to about 105° C. respectively. The rotation speed of the screw set comprised of the first screw 1, the second screw 6, the third screw 14 and the fourth screw 9 is adjustably in the range of about 15 r/min to about 260 r/min. Part of the oils is squeezed from bar cage 8 and the squeezed oilseed materials are extruded through die nozzle 11 and cooled to about 50° C. to about 60° C. before being fed to an oil extractor.

The extruded oilseed materials prepared by the above extrusion processing process for pretreating oilseeds for solvent extraction of oil include one or more extruded oilseeds selected from the group comprised of for example, soybeans, corn germs, peanuts, sunflower seeds, rape seeds, flax seeds, mustard seeds and cotton seeds.

The present invention has the following advantages over the prior art:

The oilseed extrusion equipment according to the present invention useful for pretreating oilseeds for solvent extraction of oil utilizes a whole of cylinder-conical-cylinder combinational screw having a relatively small length-diameter ratio and a relatively large compression ratio so that the screw of the same compression ratio is relatively short in length and thus the whole extrusion equipment is small and compact in size, thereby reducing its costs of manufacture, use and maintenance.

The present invention sets forth the reasonable parameters suitable for the above-said processing process and processing equipment for the extrusion of oilseeds, the parameters not being available in the prior art.

### BRIEF DESCRIPTION OF THE DRAWINGS

A more complete understanding of the present invention may be obtained by reference to the following Detailed Description when taken in conjunction with the accompanying Drawings wherein:

FIG. 1 is a top view of an oilseed extrusion equipment according to embodiments the present invention;

FIG. 2 is a half-exploded front view of the oilseed extrusion equipment according to embodiments of the present invention;

FIG. 3A illustrates a cross-sectional view of shaft A according to embodiments of the present invention; and

FIG. 3B illustrates a cross-sectional view of shaft B according to embodiments of the present invention.

### DETAILED DESCRIPTION OF ILLUSTRATIVE EMBODIMENTS OF THE INVENTION

Various embodiments of the present invention will now be described more fully with reference to the accompanying drawings. The invention may, however, be embodied in many different forms and should not be construed as limited to the embodiments set forth herein; rather, the embodiments are provided so that this disclosure will be thorough and complete, and will fully convey the scope of the invention to those skilled in the art.

### Working Example

The present invention is further illustrated by the following not-limiting example in conjunction with the drawings.

The oilseed extrusion equipment according to exemplary embodiments of the present invention is primarily comprised of, for example, an axially bisectable barrel set and a screw set. In a typical embodiment, the barrel set is comprised of a first barrel 2, a second barrel 4, a third barrel 5 and a fourth barrel 7 and a bar cage 8. The barrels 2, 4, 5, 7 and the bar cage 8 are axially bisectable and the whole of the barrel set is thus also axially bisectable. The first barrel 2, the second barrel 4, the third barrel 5, the fourth barrel 7 and the bar cage 8 are assembled in the order of numbering and can be closed when in operation by locking an upper part and lower part of each of the above-said barrels 2, 4, 5, 7 and the bar cage 8 with fasteners.

In a typical embodiment, the screw set is comprised of a main shaft 17, a first screw 1, a second screw 6, a third screw 14 and a fourth screw 9. Each screw 1, 6, 14, 9 is installed enclosing main shaft 17 in the mentioned order and rotates with main shaft 17. The first screw 1, the second screw 6, the third screw 14 and the fourth screw 9 enclosing main shaft 17 have external threads in opposite rotational direction to continuous internal threads on an inner surface of the second barrel 4, the third barrel 5 and the fourth barrel 7. In a typical embodiment, the external threads of the second screw 6, the third screw 14 and the fourth screw 9 have a helix angle substantially equal to a helix angle of continuous internal threads on the inner surface of the second barrel 4, the third barrel 5 and the fourth barrel 7. The third screw 14 is a conical screw, and the first screw 1, the second screw 6 and the fourth screw 9 are all cylinder screws. A ratio of the diameter of the first screw 1 and the second screw 6 to the diameter of the fourth screw 9 is approximately 1.37. The second barrel 4 and the third barrel 5 have essentially the same length, the ratio of this length to the length of the fourth barrel 7 is approximately 0.8 and the ratio of this length to the length of bar cage 8 is approximately 0.6. The threads on the first screw 1, the second screw 6 and the third screw 14 are, for example, continuous threads while the thread on the fourth screw 9 is, for example, an interrupted thread.

According to exemplary embodiments, the first screw 1 generally corresponds to the first barrel 2 and the second barrel 4, the second screw 6 generally corresponds to the third barrel 5, the third screw 14 generally corresponds to the fourth barrel 7, and the fourth screw 9 generally corresponds to bar cage 8. In a typical embodiment, the first screw 1 is connected to the second screw 6 through restrictive ring 16, the second screw 6 is connected to the third screw 14 through restrictive ring 15, the third screw 14 is connected to the fourth screw 9 through smooth ring 13, and the fourth screw 9 has restrictive ring 12 mounted thereon.

The volume between the end surface of the fourth screw 9 and the internal surface of a die plate 10 may be, for example, 10 times an output volume produced when the end of the fourth screw 9 rotates one revolution. The screw set has a length-diameter ratio of approximately 12 and produces a compression ratio of approximately 15. The die nozzle 11 of die plate 10 has a diameter of approximately Φ12 mm and a length of approximately 30 mm. After disassembling die plate 10 as well as the fasteners for the upper part and lower part of each of the above-said barrels and the bar cage 8, the two bisectable halves of the barrel set comprised of the corresponding two bisectable halves of the first barrel 2, the second barrel 4, the third barrel 5, the fourth barrel 7 and the bar cage 8 assembled together can be rotated outward on shaft A and shaft B respectively, so that the two bisectable halves of the barrel set are opened apart from each other.

In a typical embodiment, the first barrel 2 is not heated or cooled. The outer surfaces of the second barrel 4, the third barrel 5 and the fourth barrel 7 are heated by, for example, pressurized hot steam or electricity and forcedly cooled by, for example, cooling water or air, the temperatures in the barrels being automatically adjustable. The bar cage 8 is electrically heated, its electrical connection being turned on or off along with the heating or cooling of the fourth barrel 7 and its temperature being automatically adjustable.

The systemic parameters for the above extrusion equipment are as follows: the first barrel 2 is not heated or cooled, the temperatures of the second barrel 4, the third barrel 5 and the fourth barrel 7 are automatically adjustably at approximately 85° C., 90° C. and 95° C. respectively; the rotation speed of the screw set comprised of the first screw 1, the second screw 6, the third screw 14 and the fourth screw 9 is 200 r/min.

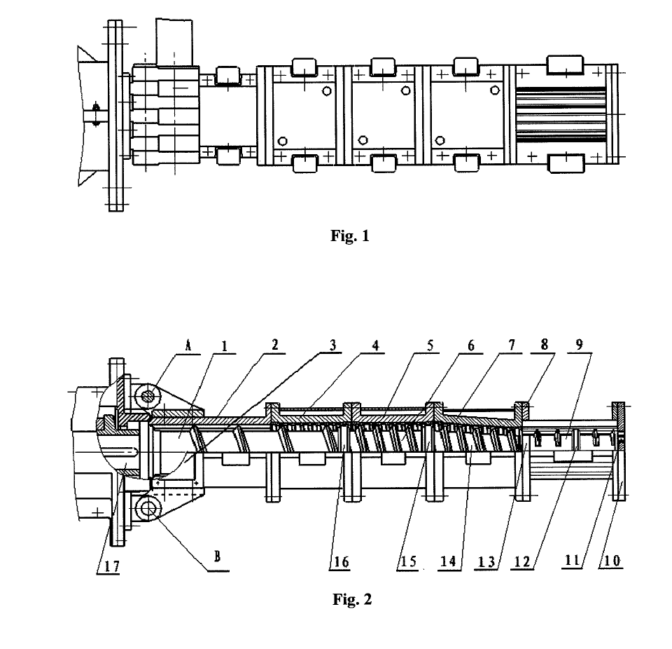

Before extrusion, the oilseed raw materials having a moisture content percentage ≧15% are subjected to removing impurities, removing stones and removing iron; dried at a low drying temperature below 45° C. to make the moisture content percentage ≦15%; and then removing or no removing the hull of oilseeds; comminuted and passed through a sieve having a pore diameter of approximately Φ4 mm. The oilseeds treated as above are fed through feeding hole 3 of the extrusion processing equipment into the equipment for extrusion processing (see FIG. 1 and FIG. 2). The comminuted oilseed materials are passed into the extrusion chamber formed by the outer surface of the first screw 1, the second screw 6, the third screw 14 and the fourth screw 9 and the inner surface of the first barrel 2, the second barrel 4, the third barrel 5, the fourth barrel 7 and bar cage 8, and rotate with main shaft 17, the first screw 1, the second screw 6, the third screw 14 and the fourth screw 9. The materials in the extrusion chamber are heated or cooled in each of the barrels and the bar cage by heat conduction. After the extruded oilseed materials pass through the first screw 1, the second screw 6, the third screw 14 and the fourth screw 9, part of the oils is squeezed from bar cage 8 and the squeezed oilseed materials are extruded through die nozzle 11 of die plate 10 and cooled from about 50° C. to about 60° C. before being fed to an oil extractor.

The extruded oilseed materials prepared by the above extrusion processing process for pretreating oilseeds for solvent extraction of oil include one or more extruded oilseeds selected from the group comprised of soybeans, corn germs, peanuts, sunflower seeds, rape seeds, flax seeds, mustard seeds and cotton seeds.

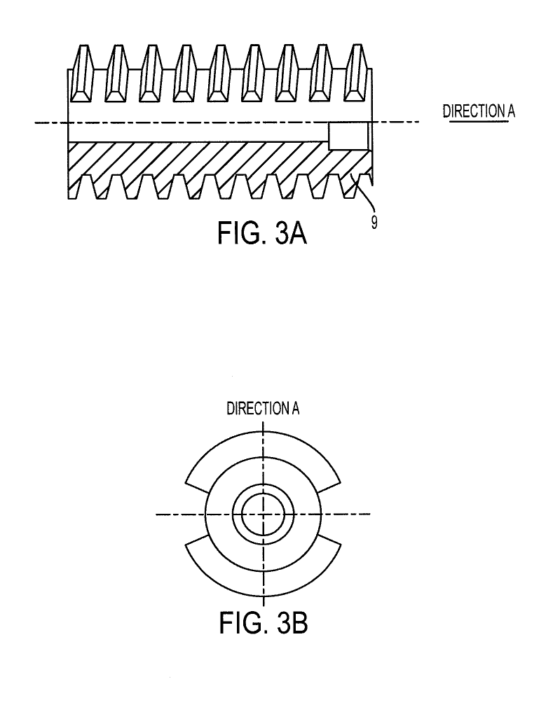

FIGS. 3A-3B illustrate a cross-sectional view of shaft A and shaft B, respectively, according to embodiments of the present invention

Although various embodiments of the apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. An extrusion processing equipment for oilseeds, characterized in that said extrusion processing equipment is primarily comprised of an axially bisectable barrel set and a screw set; the barrel set is comprised of a first barrel 2, a second barrel 4, a third barrel 5 and a fourth barrel 7 and a bar cage 8, wherein the barrels and the bar cage are axially bisectable and the whole of the barrel set is thus also axially bisectable, the first barrel 2, the second barrel 4, the third barrel 5, the fourth barrel 7 and the bar cage 8 are assembled in the order of numbering and can be closed when in operation by locking the upper part and lower part of each of the above-said barrels and the bar cage with fasteners; the screw set is comprised of a main shaft 17, a first screw 1, a second screw 6, a third screw 14 and a fourth screw 9, wherein each screw is installed enclosing main shaft 17 in the mentioning order and rotates with main shaft 17; the first screw 1, the second screw 6, the third screw 14 and the fourth screw 9 enclosing main shaft 17 have external threads in the opposite rotational direction to the continuous internal threads on the inner surface of the second barrel 4, the third barrel 5 and the fourth barrel 7; the external threads of the second screw 6, the third screw 14 and the fourth screw 9 have a helix angle substantially equal to the helix angle of the continuous internal threads on the inner surface of the second barrel 4, the third barrel 5 and the fourth barrel 7; the screw set is a cylinder-conical-cylinder combinational screw, wherein the third screw 14 is a conical screw, and the first screw 1, the second screw 6 and the fourth screw 9 are all cylinder screws; the threads on the first screw 1, the second screw 6 and the third screw 14 are continuous threads, and the thread on the fourth screw 9 is an interrupted thread; the first screw 1 generally corresponds to the first barrel 2 and the second barrel 4, the second screw 6 generally corresponds to the third barrel 5, the third screw 14 generally corresponds to the fourth barrel 7, and the fourth screw 9 generally corresponds to bar cage 8; the first screw 1 is connected to the second screw 6 through restrictive ring 16, the second screw 6 is connected to the third screw 14 through restrictive ring 15, the third screw 14 is connected to the fourth screw 9 through smooth ring 13, and the fourth screw 9 has restrictive ring 12 mounted thereon; after disassembling die plate 10 as well as the fasteners for the upper part and lower part of each of the above-said barrels and the bar cage, the two bisectable halves of the barrel set comprised of the corresponding two bisectable halves of the first barrel 2, the second barrel 4, the third barrel 5, the fourth barrel 7 and bar cage 8 assembled together can be rotated outward on shaft A and shaft B respectively so that the two bisectable halves of the barrel set are opened apart from each other; the first barrel 2 is not heated or cooled; the outer surfaces of the second barrel 4, the third barrel 5 and the fourth barrel 7 are heated by pressurized hot steam or electricity and forcedly cooled by cooling water or air, the temperatures in the barrels being automatically adjustable; bar cage 8 is electrically heat ed, its electrical connection being turned on or off along with the heating or cooling of the fourth barrel 7 and its temperature being automatically adjustable.

2. The extrusion processing equipment for oilseeds according to claim 1, characterized in that the volume between the end surface of the fourth screw 9 and the internal surface of die plate 10 will be 2 to 20 times the output volume produced when the end of the fourth screw 9 rotates one revolution; the screw set has a length-diameter ratio of 3-20 and produces a compression ratio of 5-35; the ratio of the diameter of the first screw 1 and the second screw 6 to the diameter of the fourth screw 9 is 1.01-4.0; the second barrel 4 and the third barrel 5 have essentially the same length, the ratio of this length to the length of the fourth barrel 7 is 1-0.3 and the ratio of this length to the length of bar cage 8 is 1-0.2; the die nozzle 11 of die plate 10 has an adjustable diameter ranging from 4 mm-16 mm and an adjustable length ranging from 8 mm to 50 mm.

3. An extrusion processing process for pretreating oilseeds for solvent extraction of oil, characterized in that said process comprises: subjecting the oilseed raw materials having a moisture content percentage ≧15% to cleaning; drying the materials at a low drying temperature below 50° C. to make the moisture content percentage ≦15%; removing or no removing the hull of oilseeds; comminuting the oilseeds and passing the comminuted oilseeds through a sieve having a pore diameter of 2 m-5 mm; feeding the oilseeds treated as above through feeding hole 3 of the extrusion processing equipment according to claim 1 into the equipment for extrusion processing, wherein the first barrel 2 is not heated or cooled, the temperatures of the second barrel 4, the third barrel 5 and the fourth barrel 7 are automatically adjustably in the range of 10° C.-95° C., 10° C.-100° C. and 20° C.-105° C. respectively, the rotation speed of the screw set comprised of the first screw 1, the second screw 6, the third screw 14 and the fourth screw 9 is adjustably in the range of 15 r/min-260 r/min, part of the oils is squeezed from bar cage 8 and the squeezed oilseed materials are extruded through die nozzle 11 and cooled to 50° C.-60° C. before being fed to an oil extractor.

4. The extruded oilseed materials prepared by the extrusion processing process for pretreating oilseeds for solvent extraction of oil according to claim 3, characterized in that said extruded oilseed materials include one or more extruded oilseeds selected from the group comprised of soybeans, corn germs, peanuts, sunflower seeds, rape seeds, flax seeds, mustard seeds and cotton seeds.

5. The extrusion processing process for pretreating oilseeds for solvent extraction of oil according to claim 3, characterized in that said cleaning includes removing impurities, removing stones and removing iron.
